(19) United States
(12) Patent Application Publication
(10) Pub. No.: US 2026/0198450 A1
(43) Pub. Date: Jul. 16, 2026

(54) FLUSHING TOILET FOR CAT

(71) Applicant: Hululu Pet Technology, Inc., Taichung City (TW)

(72) Inventor: Chih-Sheng WANG, Taichung City (TW)

(21) Appl. No.: 19/127,823

(22) PCT Filed: Nov. 22, 2023
(86) PCT No.: PCT/US2023/080875

§ 371 Date: May 7, 2025

Related U.S. Application Data
(60) Provisional application No. 63/482,809, filed on Feb. 2, 2023.

(51) Int. Cl. A01K 1/01

(52) U.S. Cl. CPC A01K 1/011; A01K 1/0121

(57) ABSTRACT

A flushing toilet for a cat is provided which can be placed on a regular household toilet. The flushing toilet includes a basin body, an inflow module, a cat litter supply module, a sensor, and a controller. The basin body includes a bottom gate. The inflow module is configured to supply water to the basin body. The cat litter supply module is configured to provide cat litter to the basin body. The sensor is configured to detect a use condition of the basin body. When the sensor detects that the basin body has been used, the controller is configured to control the inflow module to supply water to the basin body, to control the bottom gate to be opened and closed, and then to control the cat litter supply module to dispense the cat litter to the basin body.

### REFERENCE TO RELATED APPLICATION

The present application claims the priority of U.S. provisional application No. 63/482,809, filed on Feb. 2, 2023, the entirety of which is incorporated herein by reference.

### BACKGROUND

### Technical Field

The present invention relates to a pet toilet, and in particular, to a flushing toilet for a cat that may be perfectly integrated into a general household toilet, and may be quickly disassembled and automatically cleaned.

### Related Art

Cleaning pet waste has always been a headache for an owner, currently, the preferred solution on the market is individual pet-specific toilets. Taking the example of a pet cat, CatGenie® fully automatic cat toilet is currently more popular in the market, which processes waste by first scooping up waste mixed with cat litter, crushing it, mixing it with water, and then draining it into the household toilet through a dedicated pipeline. Then, it goes through three cycles of cleaning and washing the special cat litter and the litter box with clean water. Finally, the cat litter and litter box are dried.

However, this cat toilet seems convenient but has the following drawbacks. (1). The cat toilet is bulky and takes up a significant amount of space in the bathroom. (2). A primary material of the specialized cat litter is PP (polypropylene), which is completely insoluble in water and can easily clog pipes and toilets. (3). It often fails to clean thoroughly, leaving waste residue in the cat litter. Subsequent washing and drying can result in the entire environment being permeated with the smell of waste (4). Each operation cycle is quite time-consuming and energy-intensive because of the numerous cleaning steps required after single use. It takes over half an hour, and during the cleaning process, it cannot be used by other cats. Additionally, it consumes a significant amount of water and electricity resources. (5). The overall structure is quite complex, resulting in high cost, and a low reliability and service life.

Further, after checking the existing patent literature, there are also related patent precedents that integrate the pet toilet on the toilet. For example, Taiwanese Utility Model Patent No. M456694 “IMPROVED STRUCTURE OF FLUSHING TOILET SEAT FOR CAT” discloses a litter box with many through-holes placed on the toilet. However, this utility model patent does not use cat litter, which contradicts the natural behavior of cats to cover their excrement with cat litter. This behavior may be challenging to change through training. Additionally, this patent technology lacks automatic cleaning and still requires manual cleaning of excrement, which is inconvenient.

In addition to the foregoing patent literature, there is also Chinese patent application publication No. CN106305438A “FLIP-TYPE FLUSHING TYPE UNATTENDED CAT TOILET”, which discloses a device integrated in the toilet and equipped with an automatic cat litter replenishment. However, the device is not practical, since the urine of the cat sticks to a bottom plate together with the cat litter, which cannot be cleaned up. Besides, this prior patent is obviously to convert a human toilet into a dedicated toilet for the pet cat and is not suitable for use by humans.

Therefore, a cat flushing toilet that can achieve automatic flushing, full automation in cleaning, and can be shared by pet cats and owners on a toilet while reducing resource and energy consumption has become a highly anticipated product for the general public

### SUMMARY

One of objects of one or some embodiments of the instant disclosure is to provide a flushing toilet for a cat. The toilet may be integrated into a general household toilet, which not only allow normal use by humans but also achieve automatic cleaning of a pet cat's excrement and automatic cleaning of the toilet

To solve the above problems, one or some embodiments provide a flushing toilet for a cat, including a basin body, an inflow module, a cat litter supply module, a sensor, and a controller. The basin body includes a bottom gate. The inflow module is arranged on the basin body and configured to supply water to the basin body. The cat litter supply module is arranged on the basin body. The sensor is arranged in the basin body or the cat litter supply module. The controller is electrically connected to the bottom gate of the basin body, the inflow module, the cat litter supply module, and the sensor. When the sensor detects that excrement exists in the basin body or detects that the pet cat has used the basin body, the controller is configured to control the inflow module to supply water to the basin body, control the bottom gate to be opened and closed, and control the cat litter supply module to dispense the cat litter to the basin body.

Based on the above, the flushing toilet for a cat of some embodiments may be quickly arranged or placed directly on a regular household toilet. When a person desires to use the regular household toilet, the person can simply move the flushing toilet for a cat, which does not affect the normal use of the regular household toilet. In addition, the flushing toilet for a cat of some embodiments may further be automatically flushed and cleaned. In addition, the cat flush toilet of the present invention can automatically flush and clean. It not only automatically cleans pet excrement but also simultaneously cleans the toilet, maintaining cleanliness and eliminating odors. It can also effectively dispose of wastewater containing excrement through the toilet.

According to an embodiment of the instant disclosure, it may employ two-stage flushing steps. The first stage directly flushes away excrement, and the second stage discharges all the water once it reaches a certain level. According to another embodiment of the instant disclosure, it may also take a plurality of stages of the same flushing step, that is, each stage may discharge all the water once it reaches a specific level. In the step where all the water is discharged once it reaches a certain level, not only does it thoroughly clean the entire toilet, but the force of gravity during the discharge of the stored water can also effectively flush excrement from the household toilet, maintaining the cleanliness of both the flushing toilet for a cat and the household toilet.

To solve the above problems, the present invention provides a flushing toilet for a cat, which includes a basin body, an inflow module, a sensor, and a controller. The basin body includes a bottom gate and an accommodating slot. The bottom gate is arranged in the accommodating slot. The basin body is selectively arranged on a toilet. The inflow module is arranged on the basin body and configured to supply water to the accommodating slot. The sensor is arranged on the basin body. The controller is electrically connected to the bottom gate of the basin body, the inflow module, and the sensor. When the sensor detects that excrement exists in the accommodating slot or detects that a pet has used the basin body, the controller is configured to control the flushing module to supply water to the accommodating slot, and control the bottom gate to be opened or closed.

### BRIEF DESCRIPTION OF THE DRAWINGS

The disclosure will become more fully understood from the detailed description given herein below for illustration only, and thus not limitative of the disclosure, wherein:

FIG. 1 is a perspective view of an exemplary embodiment of the instant disclosure in a use state.

FIG. 2 is a perspective view of an exemplary embodiment of the instant disclosure.

FIG. 3 is a perspective view of the internal components according to an exemplary embodiment of the instant disclosure.

FIG. 4A is a perspective view of the cat litter supply module according to an exemplary embodiment of the instant disclosure.

FIG. 4B is a cross-sectional view of the cat litter supply module according to an exemplary embodiment of the instant disclosure.

FIG. 4C is a perspective view of the internal components of the cat litter supply module according to an exemplary embodiment of the instant disclosure.

FIG. 5A is a perspective view of the bottom gate according to an exemplary embodiment of the instant disclosure.

FIG. 5B is a cross-sectional view of a line segment A-A of FIG. 5A.

FIG. 6A is a bottom view of the bottom gate with the slider in the first position according to an exemplary embodiment of the instant disclosure.

FIG. 6B is a bottom view of the bottom gate with the slider in the second position according to an exemplary embodiment of the instant disclosure.

FIG. 7 is a perspective view of another exemplary embodiment of the instant disclosure.

FIG. 8A is a perspective view of removing the cat litter supply module, the outer cover, and the support frame according to another exemplary embodiment of the instant disclosure, where the bottom gate is in the closed state.

FIG. 8B is a perspective view of the bottom gate and the drying module according to another exemplary embodiment of the instant disclosure, where the bottom gate is in the closed state.

FIG. 8C is a side view of the bottom gate and the drying module according to another exemplary embodiment of the instant disclosure, where the bottom gate is in the closed state.

FIG. 9A is a perspective view of removing the cat litter supply module, the outer cover, and the support frame according to another exemplary embodiment of the instant disclosure, where the bottom gate is in the opened state.

FIG. 9B is a perspective view of the bottom gate and the drying module according to another exemplary embodiment of the instant disclosure, where the bottom gate is in the opened state.

FIG. 9C is a side view of the bottom gate and the drying module according to another exemplary embodiment of the instant disclosure, where the bottom gate is in the opened state.

FIG. 10A is a cross-sectional view of a line segment B-B in FIG. 7, where the water absorption module is in the first state and the drying module is removed.

FIG. 10B is a cross-sectional view of a line segment B-B in FIG. 7, where the water absorption module is in the second state and the drying module is removed.

### DETAILED DESCRIPTION

Prior to the description of a flushing toilet for a cat 1 according to one or some embodiments is provided, it is understood that in the following descriptions, similar elements are denoted by identical reference numbers. Moreover, the figures in the instant disclosure are provided merely for illustrative purposes and may not necessarily be drawn to scale, and not all the details of the instant disclosure may be shown in the figures.

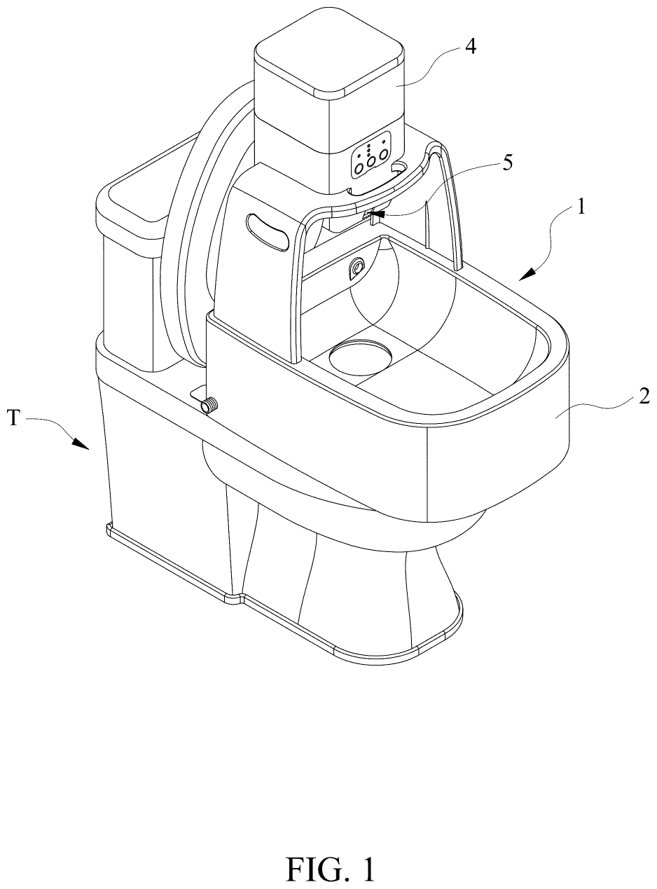

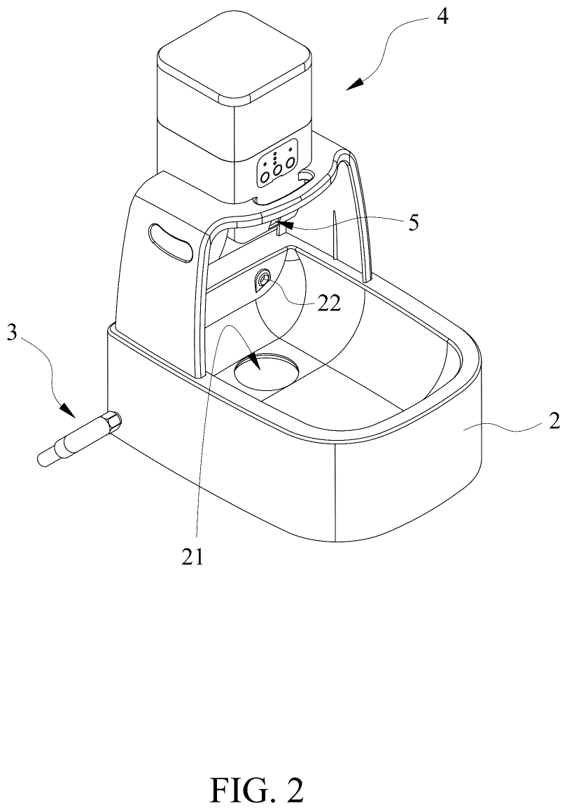

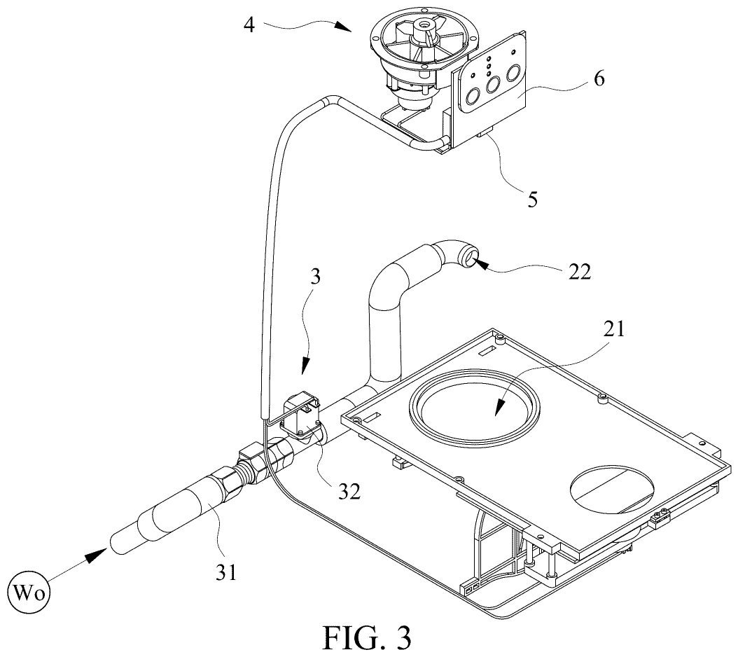

Referring to FIG. 1, FIG. 2, and FIG. 3, FIG. 1 is a perspective view of an exemplary embodiment of the instant disclosure in the use state. FIG. 2 is a perspective view of an exemplary embodiment of the instant disclosure in the non-use state. FIG. 3 is a perspective view of the internal components according to an exemplary embodiment of the instant disclosure. As shown in the figure, the flushing toilet for a cat 1 in the embodiment includes a basin body 2, an inflow module 3, a cat litter supply module 4, a sensor 5, and a controller 6.

The basin body 2 may be arranged or directly placed on a regular household toilet T, and the basin body 2 includes a bottom gate 21 and a water outlet 22. After the basin body 2 is arranged or placed on the toilet T, the bottom gate 21 is directly connected to the household toilet T. In this way, the flushing toilet for a cat 1 and the household toilet T may share a common septic system without the need for additional feces disposal pipes.

The inflow module 3 includes a water pipe 31 and a filling valve 32. An end of the water pipe 31 is connected to an external water source Wo, and the other end is connected to the water outlet 22 of the basin body 2. The filling valve 32 is arranged on the water pipe 31 and is electrically connected to the controller 6. The inflow module 3 is installed within the basin body 2, but it is not limited to the internal placement and is primarily used to provide clean water to the basin body 2 for flushing. As for the water supply source, in this embodiment, the external water source Wo is connected. As for the water supply source, in this embodiment, it is connected to an external water source Wo, which can be linked to the faucet inside the restroom or a three-way connector for toilet tank water supply. Alternatively, it can also share the water tank of the toilet T, drawing water from the toilet tank, or use other methods to supply water.

The cat litter supply module 4 is arranged above the basin body 2 and may directly dispense cat litter into the basin body 2, to accommodate the cat's habit of using cat litter for excretion. The sensor 5 is an infrared sensor integrated in the cat litter supply module 4 to detect a pet's use of the basin body 2. In addition, the sensor 5 may also be arranged on the basin body 2, or simultaneously be arranged on the basin body 2 and the cat litter supply module 4. Besides, the sensor 5 may also be an image sensor for identifying pets or excrement.

The controller 6 is mounted to the cat litter supply module 4, and is electrically connected to the bottom gate 21 of the basin body 2, the inflow module 3, the cat litter supply module 4, and the sensor 5, allowing it to control these components. Based on the above, when the sensor 5 detects that excrement exists in the basin body 2 or detects that the pet cat has used the basin body 2 and the pet cat leaves, the controller 6 is configured to immediately control the inflow module 3 to supply water to the basin body 2. Also, the controller 6 controls the bottom gate 21 to open and then close, and controls the cat litter supply module 4 to dispense the cat litter to the basin body 2. The cat litter used in this embodiment is water-soluble cat litter, such as tofu litter and paper litter, and so on.

Specifically, in some embodiment, when the sensor 5 detects that excrement exists in the basin body 2 or detects that the pet cat has used the basin body 2, the controller 6 is configured to immediately control the bottom gate 21 to be opened and control the inflow module 3 to supply water to the basin body 2 for a specific duration. This step is intended to first flush the basin body 2 directly with a large amount of water, and flush most of the cat litter and the excrement into the household toilet. Subsequently, the controller 6 controls the bottom gate 21 to be closed and the inflow module 3 continues to supply water for another specific duration. This step is to soak and clean the remaining cat litter and excrement.

Besides, the controller 6 is configured to control the bottom gate 21 to be opened again for a specific duration. This step quickly discharges wastewater into the toilet. By a gravitational acceleration of the wastewater, the wastewater such as the cat litter and the excrement in the flushing toilet for a cat 1 is also discharged into the septic system through the household toilet. However, to thoroughly clean the flushing toilet for a cat 1 and the household toilet T, this step may be repeated many times. Finally, the controller 6 controls the inflow module 3 and the bottom gate 21 to be closed, and controls the cat litter supply module 4 to dispense the cat litter into the basin body 2 for next use.

Another embodiment of cleaning the flushing toilet for a cat is provided below. When the sensor 5 detects the presence of excrement within=in the basin body 2 or detects that the pet cat has used the basin body 2, the controller 6 immediately controls the inflow module 3 to supply water to the basin body 2 for a specific duration, to enable the water to fill the basin body 2 once it reaches a certain level. The purpose of this step is to employ soaking as a direct method to prevent excrement from adhering to the basin body 2. Subsequently, controller 6 controls the opening of bottom gate 21, enabling rapid discharge of wastewater.

Subsequently, the controller 6 closes the bottom gate 21 and the inflow module 3 continues to supply water for another specific duration, repeating the soaking step described above. The controller 6 then reopens the bottom gate 21 to allow a large amount of wastewater to be discharged into the household toilet again. Similarly, to thoroughly clean the basin body 2 and the household toilet T, this step may be performed a plurality of times. Finally, the controller 6 controls the bottom gate 21 and the inflow module 3 to be closed, and control the cat litter supply module 4 to dispense the cat litter into the basin body 2. Accordingly, in this modified embodiment, more than two times of water retention, cleaning, and drainage are used to ensure that all cat litter and excrement are expelled from the basin body 2 and the household toilet to maintain cleanliness.

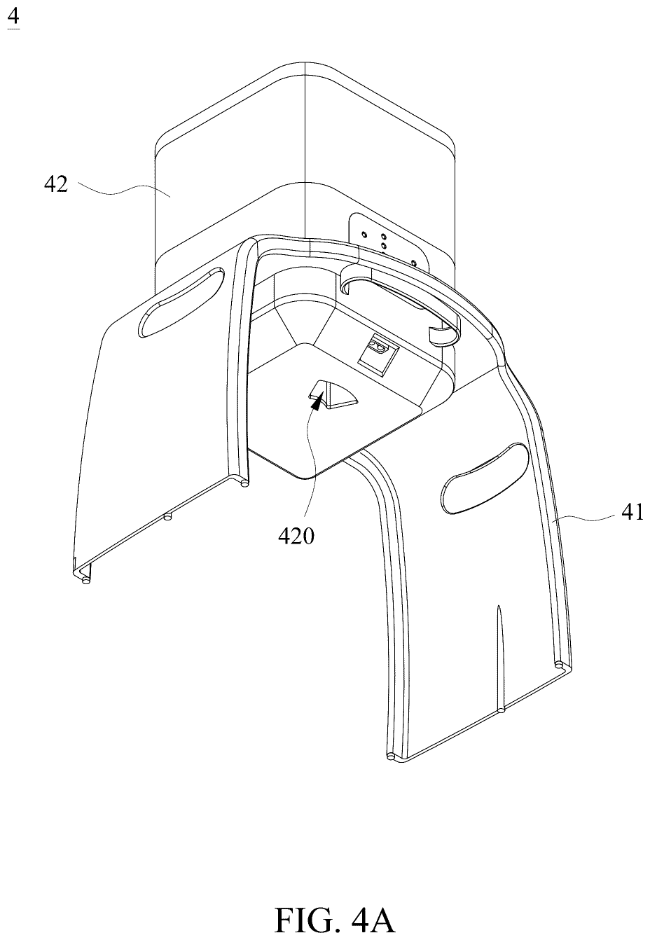

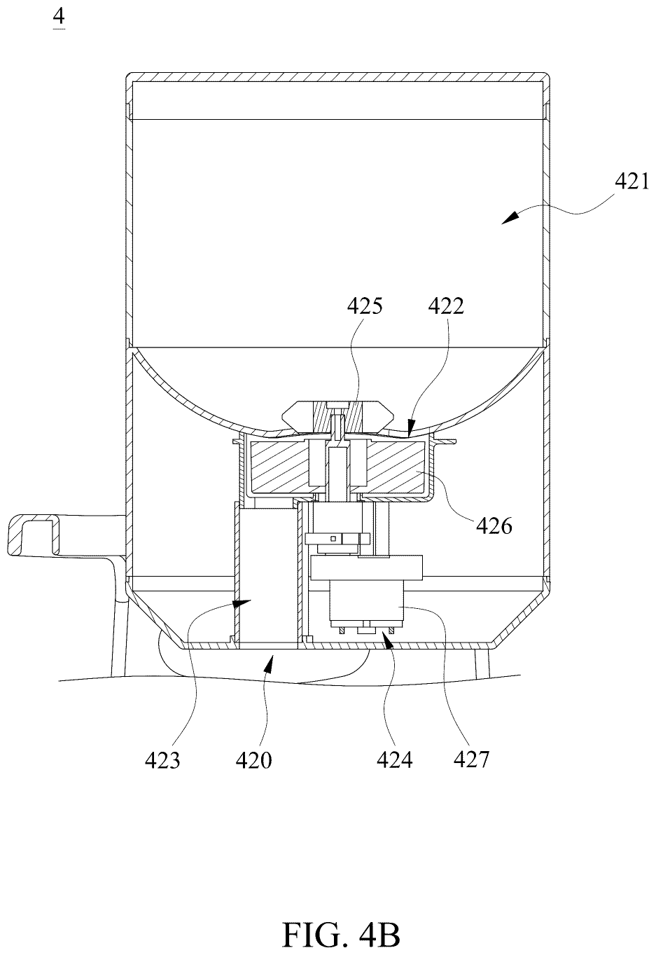

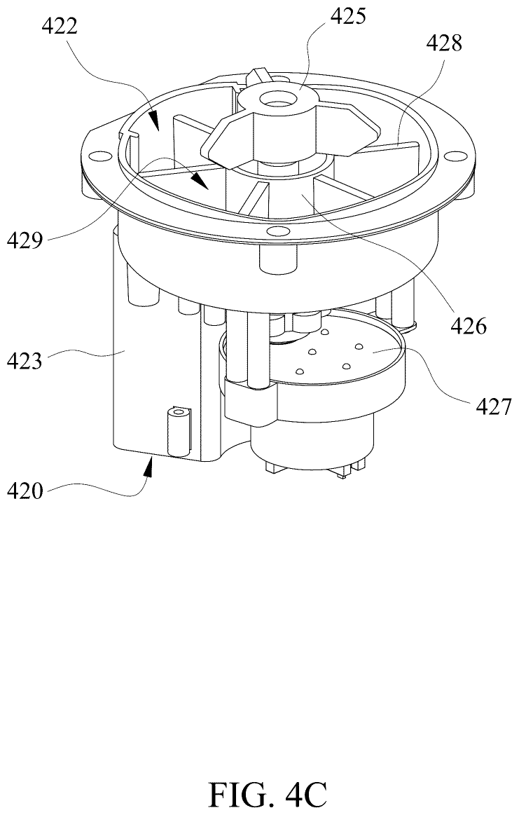

Referring to FIG. 4A, FIG. 4B, and FIG. 4C, FIG. 4A is a perspective view of the cat litter supply module according to an exemplary embodiment of the instant disclosure. FIG. 4B is a cross-sectional view of the cat litter supply module according to an exemplary embodiment of the instant disclosure. FIG. 4C is a perspective view of the internal components of the cat litter supply module according to an exemplary embodiment of the instant disclosure.

As shown in the figure, the cat litter supply module 4 of an exemplary embodiment of the instant disclosure includes a fixing frame 41 and a cat litter dispensing device 42. The fixing frame 41 in this embodiment is an arch-shaped frame and is connected to the basin body 2. The cat litter dispensing device 42 is arranged on the fixing frame 41. The cat litter dispensing device 42 is located above the basin body 2 at a certain height, and the fixing frame 41 having an appropriate height may be selected based on the height of the pet. In addition, the cat litter dispensing device 42 includes a litter outlet 420 facing the basin body 2, which is located at a bottom of the cat litter dispensing device 42. As a result, cat litter can be dispensed into the basin body 2 through the force of gravity.

The cat litter dispensing device 42 further includes a litter reservoir 421, a conveying chamber 422, a dispensing channel 423, and a conveying module 424, from top to bottom. The conveying chamber 422 is in communication with the litter reservoir 421 and is located beneath the litter reservoir 421. This configuration allows the cat litter stored in the litter reservoir 421 to be dispensed into the transport reservoir 422 by gravity, facilitating subsequent dispensing in precise amounts.

Besides, one end of the dispensing channel 423 is in communication with the conveying chamber 422, and the other end is in communication with the litter outlet 420. The dispensing channel 423 is located beneath the conveying chamber 422, so that the cat litter may be directly delivered to the discharge channel 423 by gravity from the conveying chamber 422, and finally discharged to the litter outlet 420.

In addition, the conveying module 424 is electrically connected to the controller 6 and is adapted to convey the cat litter from the litter reservoir 421 to the conveying chamber 422 and the dispensing channel 423. Further, the conveying module 424 includes a stirring wheel 425, a distributing wheel 426, and an actuator 427. The stirring wheel 425 is connected to the distributing wheel 426 in series and is located at a bottom of the litter reservoir 421. The stirring wheel 425 is mainly configured to stir the cat litter stored in the litter reservoir 421, to enable the cat litter smoothly falls into the conveying chamber 422 below.

In addition, the distributing wheel 426 is connected to the actuator 427 and located in the conveying chamber 422. The distributing wheel 426 includes a plurality of dividing plates 428 configured to divide the conveying chamber 422 into a plurality of sub-chambers 429. Each of the sub-chambers 429 is used for metering the cat litter to prevent an unexpected quantity of cat litter from being dispensed during downward delivery.

As the actuator 427 rotates the distributing wheel 426 and drives the stirring wheel 425, the stirring wheel 425 drives the cat litter to fall into a sub-chamber 429 from the litter reservoir 421. Simultaneously, the distributing wheel 426 guides the cat litter fall into the dispensing channel 423 from another sub-chamber 429. In other words, through the operation of the conveying module, the cat litter can smoothly pass from the litter reservoir 421, through the conveying chamber 422, and into the dispensing channel 423, ultimately exiting from the litter outlet 420 into the basin body 2.

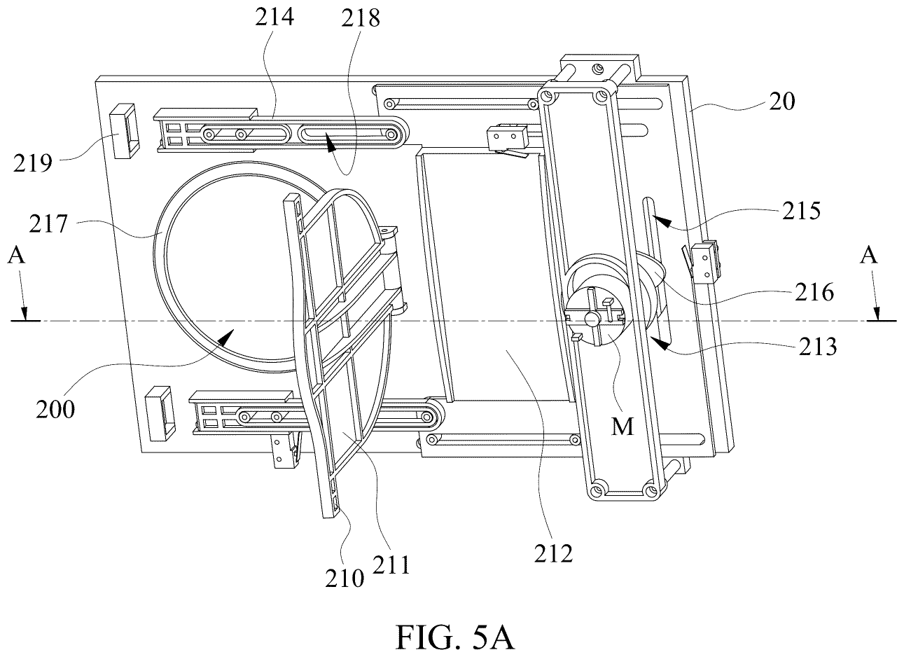

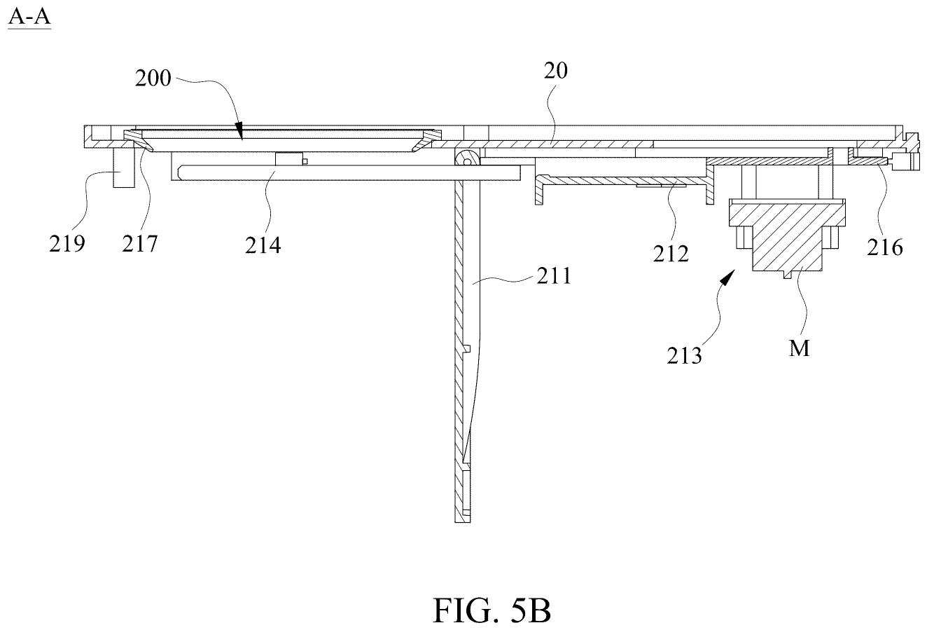

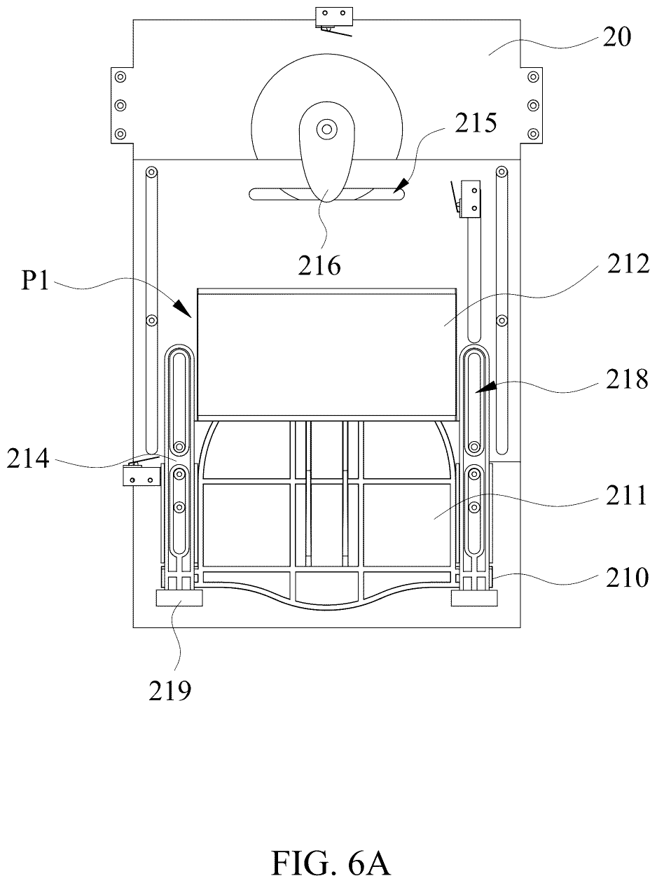

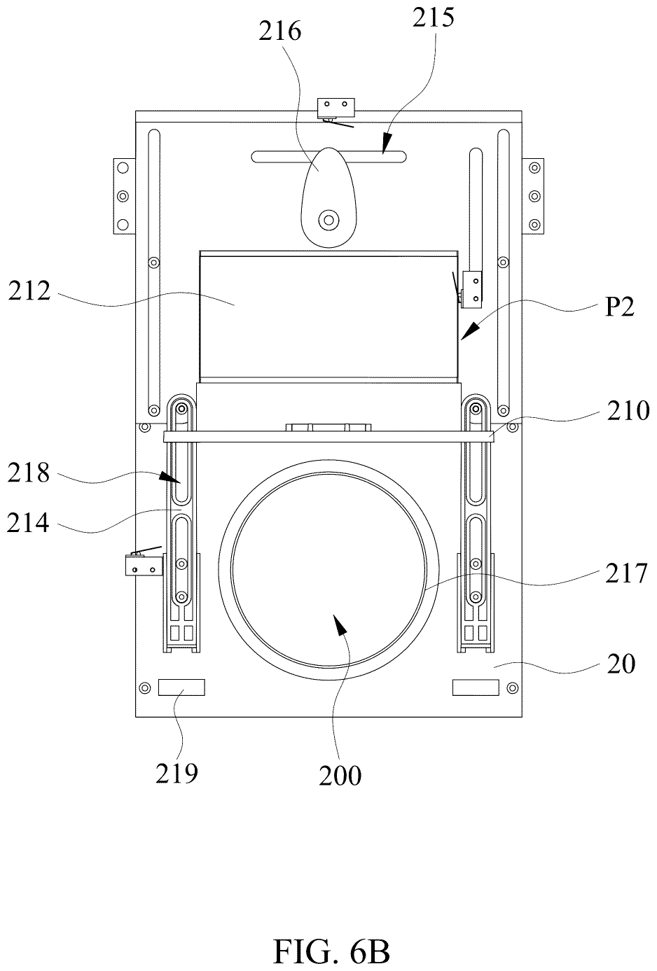

Referring to FIG. 5A, FIG. 5B, FIG. 6A, and FIG. 6B, FIG. 5A is a perspective view of the bottom gate according to an exemplary embodiment of the instant disclosure. FIG. 5B is a cross-sectional view of a line segment A-A in FIG. 5A. FIG. 6A and FIG. 6B are bottom views of the bottom gate with a slider in the first position and the second position according to an exemplary embodiment of the instant disclosure, which are to present the bottom gate 21 in two states in which the slider is actuated by a motor.

As shown in the figure, the bottom gate 21 of an exemplary embodiment of the instant disclosure mainly includes a lid 211, a slider 212, and a driver 213, one end of the lid 211 is pivotably connected to a lower surface of a bottom plate 20 of the basin body 2, and it may selectively close or open an opening 200 of the bottom plate 20. In other words, the lid 211 opens in the direction beneath the bottom plate 20 to facilitate the cat litter and excrement to naturally fall into the household toilet T after the lid 211 is opened.

Additionally, a gasket 217 is provided on the opening 200 of the bottom plate 20, which can be made of rubber, silicone, polytetrafluoroethylene (Teflon), or other suitable materials. The gasket 217 is used to enhance the sealing between the opening 200 and the lid 211, preventing water leakage. The slider 212 is slidably arranged on the lower surface of the bottom plate 20. The driver 213 is arranged on one side of the bottom plate 20 without affecting the operation of the lid 211. The driver 213 is configured to drive the slider 212 to slide between a first position P1 (as shown in FIG. 6A) and a second position P2 (as shown in FIG. 6B), and cause the lid 211 to be fully opened or closed at the two positions.

Specifically, when the slider 212 slides to the first position P1, the slider 212 is stopped under of the lid 211, and the lid 211 is blocked by the slider 212, thereby closing the opening 200 of the bottom plate 20. Conversely, when the slider 212 slides to the second position P2, the slider 212 moves away from under the lid 211, allowing the lid 211 to open naturally due to gravity and uncover the opening 200 in the bottom plate 20. In this way, by the reciprocal sliding of the slider 212 between the first position P1 and the second position P2, the lid 211 may be switched between open and closed states.

Besides, the bottom gate 21 further includes two sliding latches 214. The two sliding latches 214 is slidably arranged on the lower surface of the bottom plate 20 and are located on the corresponding two sides of the lid 211. Each of the sliding latches 214 includes a sliding slot 218, to which the slider 212 is coupled. In this way, the slider 212 may exert a pushing force on one side of the two sliding slots 218 to push the sliding latch 214, and apply a pulling force on the other side of the sliding slots 218 to pull back the sliding latch 214.

In addition, the lid 211 further includes two protrusions 210, which respectively protrude toward the two sliding slots 218. The lower surface of the bottom plate 20 includes two sockets 219, which respectively correspond to the two sliding latches 214. In this way, when the slider 212 is in the first position P1, the sliding latches 214 are pushed by the slider 212 and inserted into the corresponding sockets 219. In this case, the sliding latches 214 rest against the protrusions 210 of the lid 211. Conversely, when the slider 212 is in the second position P2, the sliding latches 214 are retracted from the corresponding sockets 219 by the slider 212, and the lid 211 opens the opening 200 of the bottom plate 20.

Based on the above, the sliding latches 214 in this embodiment further reinforce a structural strength between the lid 211 and the slider 212, so that the bottom gate 21 is sufficient to support weights of the cat litter, the excrement, and the wastewater in the basin body 2. In addition, because the sliding latches 214 are only pulled out of the sockets 219 when the slider 212 is near the second position P2, the lid 211 can open instantly, preventing any water leakage that might occur if the lid 211 were to open slowly.

In addition, the driver 213 specifically includes a motor M and a crank 216. The motor M serves as a power source, while the crank 216 functions as an interlocking assembly responsible for driving the slider 212 to slide. Therefore, one end of the crank 216 is connected to the motor M and the other end is coupled to the through slot 215 of the slider 212.

In this way, when the motor M drives the crank 216 to rotate, the other end of the crank 216 slides within the through slot 215, subsequently the slider 212 is further driven to slide between the first position P1 and the second position P2. In other words, through the crank 216, an output torque of the motor M may be converted into the pushing or the pulling force acting in a straight line, to push the slider 212 or pull the slider 212 back. Finally, the reciprocating sliding of the slider 212 between the first position P1 and the second position P2 is realized.

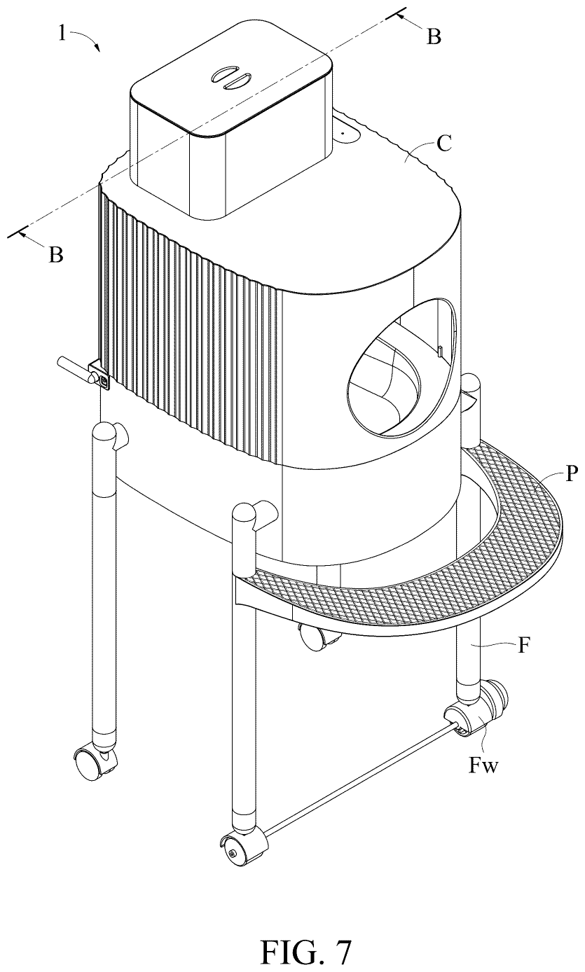

FIG. 7 is a perspective view of another exemplary embodiment of the instant disclosure. In some embodiments, the flushing toilet for a cat 1 may further include a cover C, a support frame F, and a standing platform P. The use of the cover C is to provide privacy for the cat when using the toilet, as cats have a natural inclination for privacy when using the toilet. The support frame F may include four kickstands, and each of the kickstands may be equipped with a caster Fw. In this way, a user may easily move the flushing toilet for a cat 1. For example, when someone desires to use or clean the household toilet T (see FIG. 1), the flushing toilet for a cat 1 may be easily removed. When the flushing toilet for a cat 1 is to be operated, the flushing toilet for a cat 1 may be moved back over the household toilet T. In addition, in some embodiments, a standing platform P may be mounted on the support frame F. The standing platform P may serve as a stepping board, so that the cat may use the toilet more easily.

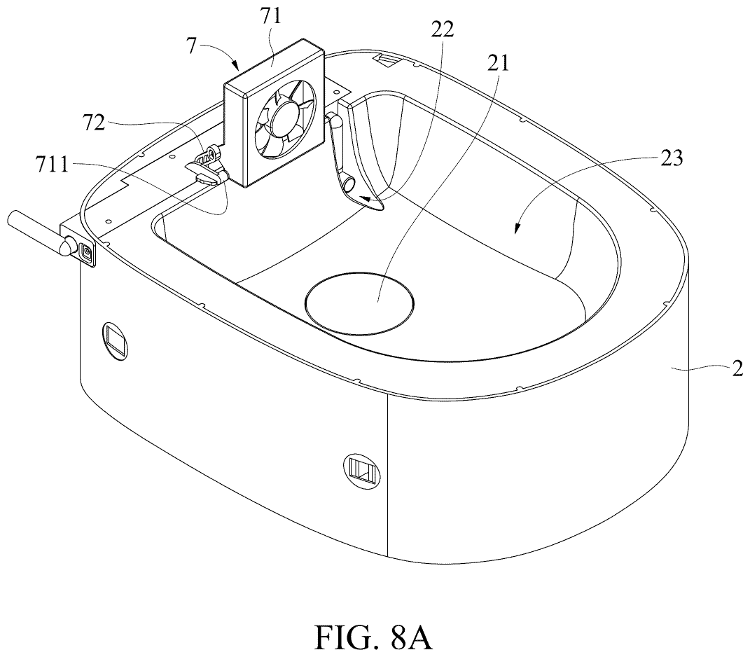

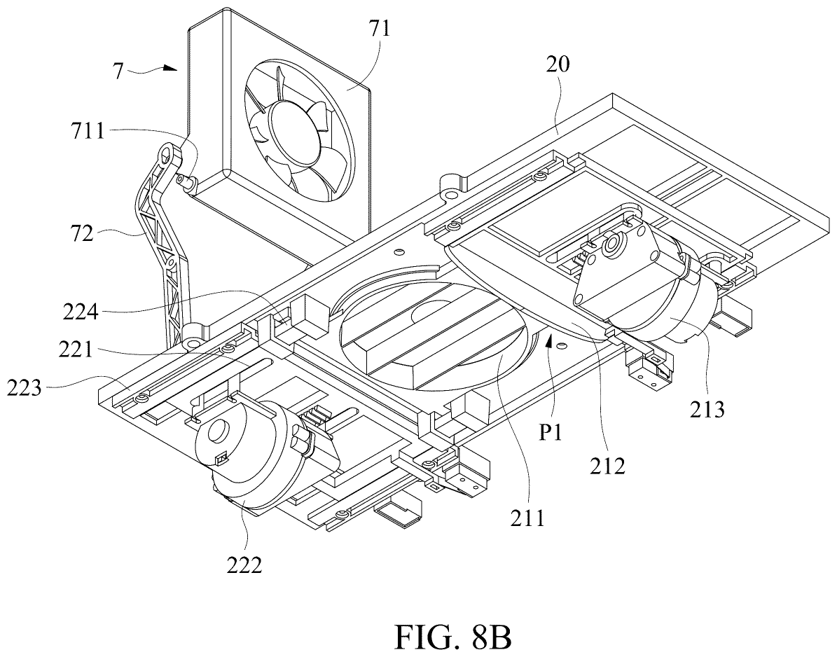

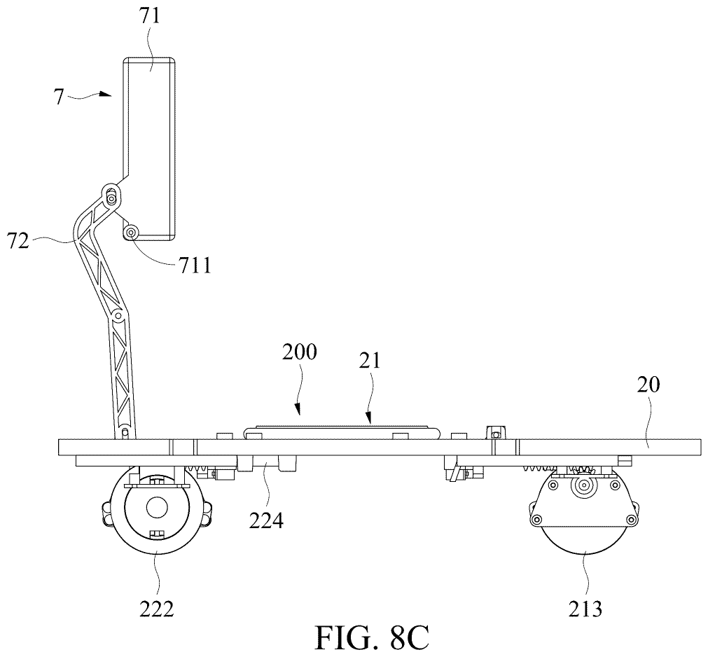

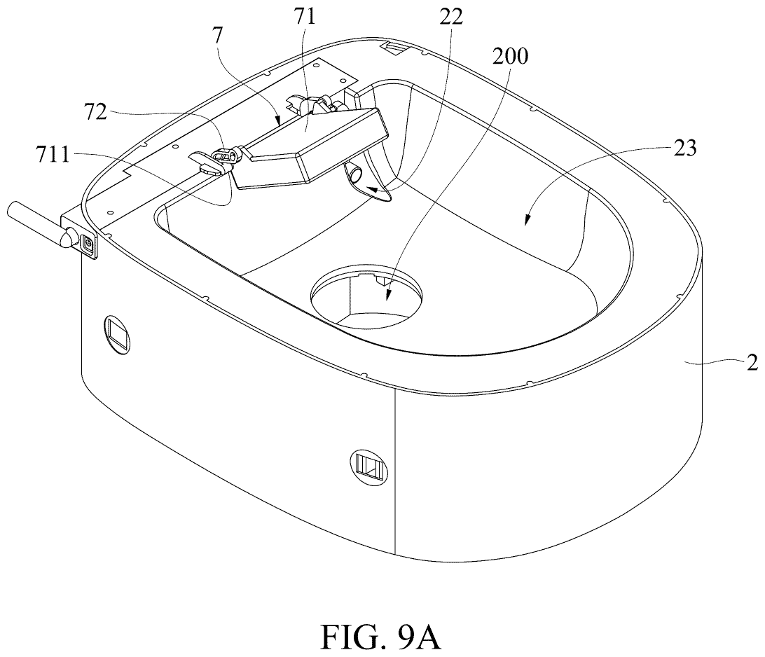

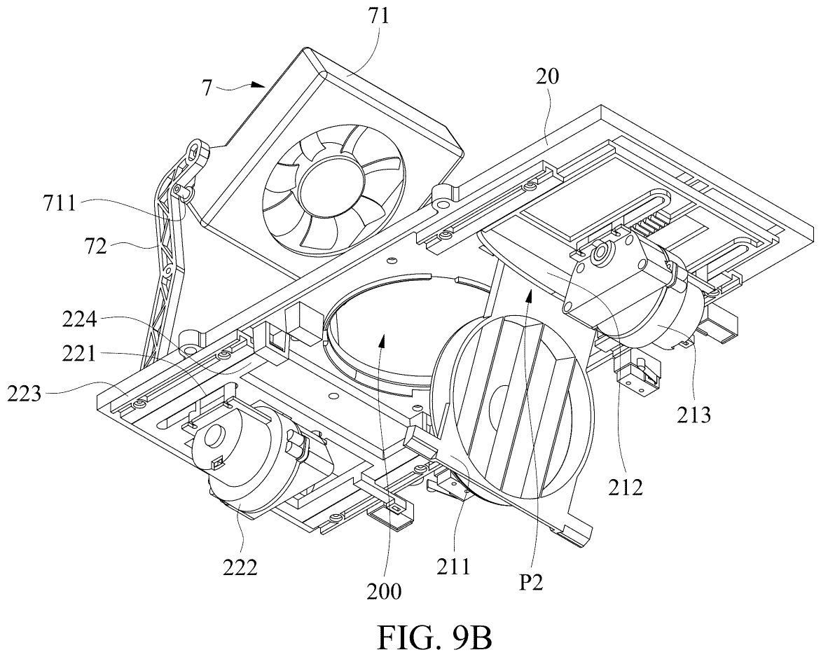

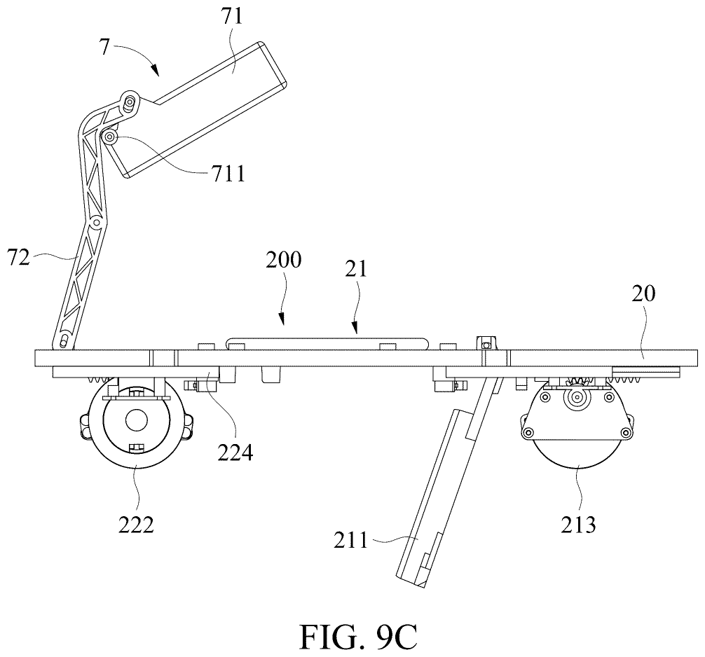

Referring to FIG. 8A, FIG. 8B, FIG. 8C, FIG. 9A, FIG. 9B, and FIG. 9C, FIG. 8A is a perspective view of removing the cat litter supply module 4, the cover C, and the support frame F according to another exemplary embodiment of the instant disclosure, in which a bottom gate 21 is in a closed state. FIG. 8B is a perspective view of the bottom gate 21 and the drying module 7 according to another exemplary embodiment of the instant disclosure, in which the bottom gate 21 is in the a closed state. FIG. 8C is a side view of the bottom gate 21 and the drying module 7 according to another exemplary embodiment of the instant disclosure, in which the bottom gate 21 is in the closed state. FIG. 9A is a perspective view of removing the cat litter supply module 4, the cover C, and the support frame F according to another exemplary embodiment of the instant disclosure, in which the bottom gate 21 is in the opened state. FIG. 9B is a perspective view of the bottom gate 21 and the drying module 7 according to another exemplary embodiment of the instant disclosure, in which the bottom gate 21 is in an opened state. FIG. 9C is a side view of the bottom gate 21 and the drying module 7 according to another exemplary embodiment of the instant disclosure, in which the bottom gate 21 is in an opened state.

As shown in the embodiments in these drawings, the main difference from the previous embodiments lies in the configuration of the bottom gate 21, and a drying module 7 is additionally arranged in this embodiment. Further, in this embodiment, the configuration of the driver 213, the lid 211, and the slider 212 is substantially the same as that of the previous embodiment, with the only difference being the power transmission method between the driver 213 and the slider 212. As shown in FIG. 9B, in this embodiment, the driver 213 is kinematically connected to the slider 212 through a gear and rack mechanism.

In addition, the bottom plate 20 is provided with a locking plate 221 and a locking driver 222 on a side opposite to the driver 213 and the slider 212. The locking plate 221 is slidably arranged a lower surface of the bottom plate 20 through a guide rail 223, and one end of the locking plate 221 facing the lid 211 is provided with a stop pin 224. The locking driver 222 is arranged on the bottom plate 20, and the driver 213 may also be kinematically connected to the slider 212 through the gear and rack, as can be seen in FIG. 8B.

When the slider 212 is in the first position P1, that is, when the bottom gate 21 is to be in a closed state, the locking driver 222 drives the locking plate 221 to slide toward the lid 211, and the stop pin 224 then blocks below the lid 211. In this way, the stop pin 224 may further ensure that the lid 211 may tightly close the opening 200 of the bottom plate 20, as shown in FIG. 8B.

The following briefly describes the operation process of the bottom gate 21 in the present embodiment. When the bottom gate 21 is to be opened, the driver 213 drives the slider 212 to return to the second position P2. And then, the locking driver 222 drives the locking plate 221 to slide away from the lid 211, so that the stop pin 224 moves away from the below the lid 211, as shown in FIG. 9B and FIG. 9C.

In some embodiments, the locking driver 222 may quickly drive the locking plate 221 to move, and the stop pin 224 is instantaneously pulled away from below the lid 211, so the lid 211 may be opened and drained instantaneously. As a result, a water leakage caused by a slow opening of the lid 211 may be avoided.

Further, when the bottom gate 21 is to be closed, the driver 213 may first drive the slider 212 to bring it into the first position P1. And then, the locking driver 222 drives the locking plate 221 to slide towards the direction of the lid 211, bringing the stop pin 224 under the lid 211. The stop pin 224 in this embodiment further reinforces a structural strength between the lid 211 and the slider 212, so that the bottom gate 21 is sufficient to support weights of the cat litter, the excrement, and the wastewater within the basin body 2.

According to another aspect, when the slider 212 is in the second position P2, that is, when the bottom gate 21 is to be in an opened state, the locking driver 222 drives the locking plate 221 to slide away from the direction of the lid 211, causing the stop pin 224 to move out from under the lid 211. In this case, the lid 211 may instantly open the opening 200 of the bottom plate 20, as shown in FIG. 9B, to realize a rapid drainage.

Still referring to FIG. 8A, FIG. 8B, FIG. 8C, FIG. 9A, FIG. 9B, and FIG. 9C, after the accommodating slot 23 is flushed and cleaned, water stains may remain. To address the issue of residual water stains in the basin 23 that can stick to cat litter after absorbing water and become difficult to remove, a drying module 7 is added to expedite the evaporation of water stains. The drying module 7 may include a fan 71 and two oscillating rods 72. The fan 71 includes two pivoting portions 711, which are respectively located on both sides of a lower end face of the fan 71, and each of the pivoting portions 711 is pivoted to the basin body 2. One end of each of the two oscillating rods 72 is pivoted to the corresponding two sides of the fan 71, and the other end is connected to the corresponding two sides of the locking plate 221.

When the bottom gate 21 is in the closed state, the locking plate 221 drives the oscillating rod 72 to cause the fan 71 to stand upright, as shown in FIG. 8A, FIG. 8B, and FIG. 8C. When the bottom gate 21 is in an opened state, the locking plate 221 drives the oscillating rod 72 to tilt the fan 71 toward the accommodating slot 23 of the basin body 2, as shown in FIG. 9A, FIG. 9B, and FIG. 9C. In this case, the controller 6 may drive the fan 71 to operate to accelerate drying of the accommodating slot 23.

In other words, in some embodiments, when the bottom gate 21 has drained, the bottom gate 21 may be opened for a specific duration to allow the fan 71 to operate to dry the accommodating slot 23. When the accommodating slot 23 has completed drying, the controller 6 controls the bottom gate 21 to be closed, the cat litter supply module 4 to dispense the cat litter into the accommodating slot 23. Based on the above, the dried accommodating slot 23 may not stick to the cat litter, which is conducive to maintaining cleanliness of the accommodating slot 23.

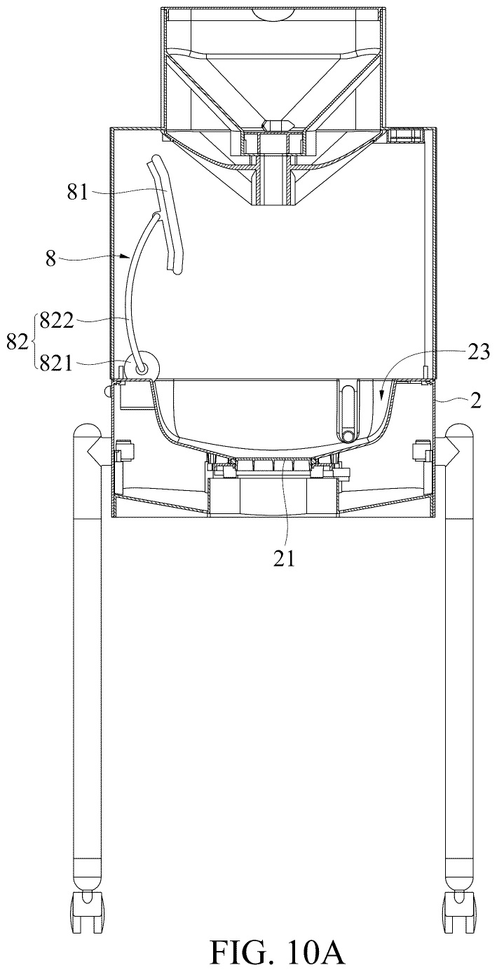

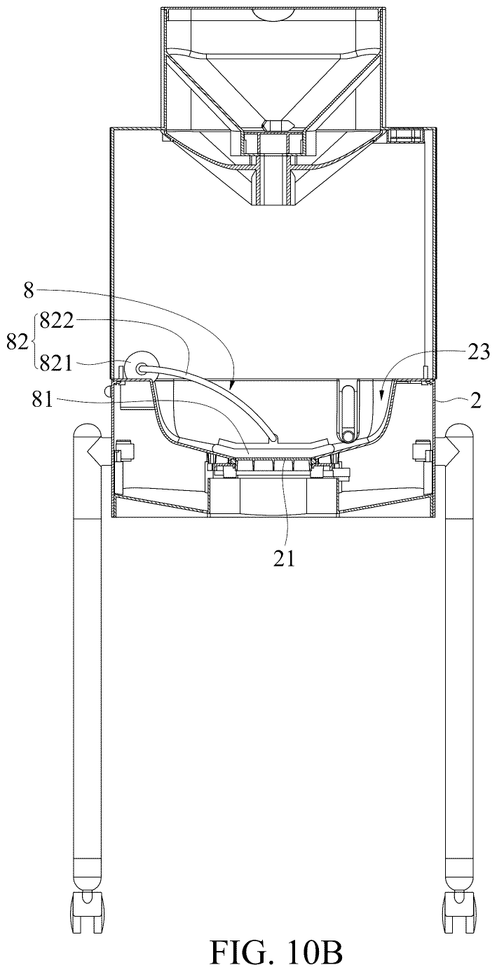

Referring to FIG. 10A and FIG. 10B, FIG. 10A is a cross-sectional view of a line segment B-B in FIG. 7, in which the water absorption module 8 is in the first state and the drying module 7 is removed. FIG. 10B is a cross-sectional view of a line segment B-B in FIG. 7, in which the water absorption module 8 is in the second state and the drying module 7 is removed.

Due to a cat's natural tendency to scratch and bury its waste in the cat litter, the accommodating slot 23 of the basin body 2 is easily scratched during this process. Therefore, after prolonged use, many scratches may accumulate on the surface of the accommodating slot 23, and these scratches may not only trap waste or cat litter but also potentially retain water stains after flushing. To address this issue, in some embodiments, aside from using materials with higher hardness for the accommodating slot 23 (such as stainless steel) to mitigate the problem of scratches, this embodiment additionally provides a water absorption module 8 to remove water stains.

Further, the water absorption module 8 includes a water absorption member 81 and a water absorption member driver 82. The water absorption member driver 82 includes a motor 821 and a connecting rod 822. The motor 821 may be arranged on an outer peripheral edge of the basin body 2. In other embodiment, the motor 821 may further be arranged inside the basin body 2. One end of the connecting rod 822 is connected to the motor 821, and the other end is connected to the water absorption member 81. The water absorption member 81 includes, but is not limited to, a sponge, a fabric, or diatomaceous earth.

The operation explanation of the water absorption module 8 are as follows. When the inflow module 3 flushes the accommodating slot 23 of the basin body 2 and the bottom gate 21 is to be closed, the motor 821 may drive the connecting rod 822, allowing the water absorption member 81 to come into contact with the surface of the accommodating slot 23 and bottom gate 21, as shown in FIG. 10B. In this case, the water absorption member 81 may absorb the water stains from the surface of the accommodating slot 23 and the bottom gate 21.

In some embodiments, time for the water absorption member 81 to contact the surface of the accommodating slot 23 and the bottom gate 21 only takes a few seconds. And then, the motor 821 may drive the connecting rod 822 again to move the water absorption member 81 away from the accommodating slot 23 and the bottom gate 21, as shown in FIG. 10A. In other words, the water absorption operation of the water absorption member 81 is completed.

In addition, in some embodiments, the drying module 7 shown in FIG. 8A to FIG. 9C may also be fitted, which may accelerate removing the water stains on the surface of the accommodating slot 23 and the bottom gate 21. That is to say, when the water absorption member 81 contacts the surface of the accommodating slot 23 and the bottom gate 21 to absorb most of the water stains, the drying module 7 is activated again to allow the fan 71 to dry the accommodating slot 23, as shown in FIG. 9A. However, after the water absorption module 8 absorbs most of the water stains, the activation time of the drying module 7 may be greatly shortened, and a service downtime caused by cleaning the toilet may be greatly shortened.

The controller 6 may include a storage medium to store instructions (in, for example, firmware or software) to perform the operations described herein. The storage medium may include any type of tangible medium, for example, any type of disk including floppy disks, optical disks, compact disk read-only memories (CD-ROMs), compact disk rewritables (CD-RWs), and magneto-optical disks, semiconductor devices such as read-only memories (ROMs), random access memories (RAMs) such as dynamic and static RAMs, erasable programmable read-only memories (EPROMs), electrically erasable programmable read-only memories (EEPROMs), flash memories, magnetic or optical cards, or any type of media suitable for storing electronic instructions.

The functions of the various elements shown in the figures, including any functional blocks described as “controller,” may be provided through the use of dedicated hardware as well as hardware capable of executing software in association with appropriate software. The functions may be provided by a single dedicated processor, by a single shared processor, or by a plurality of individual processors, some of which may be shared. Moreover, explicit use of the term “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

The above embodiments are merely examples for description, and the scope of rights claimed in the present invention should be subject to the scope of the patent application, rather than being limited to the above embodiments.

1. A flushing toilet for a cat, comprising:
a basin body, comprising a bottom gate;
an inflow module arranged on the basin body and configured to supply water to the basin body;
a cat litter supply module arranged on the basin body;
a sensor arranged in the basin body or the cat litter supply module; and
a controller electrically connected to the bottom gate of the basin body, the inflow module, the cat litter supply module, and the sensor, wherein
in response to detecting that excrement exists in the basin body or detecting that a pet has used the basin body by the sensor, the controller is configured to control the inflow module to supply water to the basin body, control the bottom gate to be opened and closed, and control the cat litter supply module to supply cat litter to the basin body:
wherein the bottom gate comprises a lid, a slider, and a driver; one end of the lid is pivotally connected to a lower surface of a bottom plate of the basin body, and an opening of the bottom plate is selectively closed or opened by the lid; the slider is slidably arranged on the lower surface of the bottom plate; the driver is arranged on the bottom plate, and is configured to drive the slider to move between a first position and a second position; in response to the slider being in the first position, the slider blocks beneath the lid and causes the lid to close the opening of the bottom plate; and in response to the slider being in the second position, the slider moves away from beneath the lid, and causes the lid to open the opening of the bottom plate.

2. The flushing toilet for a cat according to claim 1, wherein in response to detecting that the excrement exists in the basin body or detecting that the pet has used the basin body by the sensor, the controller is configured to: open the bottom gate and control the inflow module to supply water to the basin body for a specific duration; close the bottom gate and control the inflow module to continuously supply water for another specific duration; reopen the bottom gate for the specific duration; and control the inflow module to be turned off and the bottom gate to be closed, and control the cat litter supply module to dispense the cat litter to the basin body.

3. The flushing toilet for a cat according to claim 1, wherein in response to detecting that the excrement exists in the basin body or detecting that the pet has used the basin body, the controller is configured to: control the inflow module to supply water to the basin body for a specific duration; open the bottom gate; close the bottom gate and control the inflow module to continuously supply water for another specific duration; reopen the bottom gate; and control the bottom gate to be closed and the inflow module to be turned off, and control the cat litter supply module to dispense the cat litter to the basin body.

4. The flushing toilet for a cat according to claim 1, wherein the basin body comprises a water outlet, the inflow module comprises a water pipe and a filling valve, an end of the water pipe is connected to an external water source, while the other end is connected to the water outlet of the basin body, and the filling valve is arranged on the water pipe and is electrically connected to the controller.

5. The flushing toilet for a cat according to claim 1, wherein the cat litter supply module comprises a fixing frame and a cat litter dispensing device, the fixing frame is connected to the basin body, the cat litter dispensing device comprises a litter outlet, the cat litter dispensing device is arranged on the fixing frame and is located above the basin body, and the litter outlet faces the basin body.

6. The flushing toilet for a cat according to claim 5, wherein the cat litter dispensing device comprises a litter reservoir, a conveying chamber, a dispensing channel, and a conveying module; the conveying chamber is positioned beneath the litter reservoir and is in communication with the litter reservoir; the dispensing channel is located below the conveying chamber, with one end of the dispensing channel connected to the conveying chamber and the other end is in connected to the litter outlet; the conveying module is electrically connected to the controller and is adapted to convey the cat litter from the litter reservoir to the conveying chamber and the dispensing channel.

7. The flushing toilet for a cat according to claim 6, wherein the conveying module comprises a stirring wheel, a distributing wheel, and an actuator; the stirring wheel is connected to the distributing wheel and is located at a bottom of the litter reservoir; the distributing wheel is connected to the actuator and is located inside the conveying chamber; the distributing wheel comprises a plurality of dividing plates arranged in a radial pattern, which divides the conveying chamber into a plurality of sub-chambers; when the actuator rotates the distributing wheel and drives the stirring wheel, the stirring wheel drives the cat litter to fall into the plurality of sub-chambers from the litter reservoir, and the distributing wheel drives the cat litter to fall into the dispensing channel from the plurality of sub-chambers.

8. (canceled)

9. The flushing toilet for a cat according to claim 8, wherein the bottom gate further comprises at least one sliding latch slidably arranged on the lower surface of the bottom plate, the at least one sliding latch comprises a sliding slot to which the slider is coupled; the lid comprises a protrusion; the lower surface of the bottom plate comprises at least one socket; in response to the slider being in the first position, the at least one sliding latch is driven by the slider to be inserted into the at least one socket, and the at least one sliding latch blocks the protrusion of the lid; and in response to the slider being in the second position, the at least one sliding latch is driven by the slider to retract from the at least one socket, and causes the lid to open the opening of the bottom plate.

10. The flushing toilet for a cat according to claim 9, wherein the driver comprises a motor and a crank, the slider is provided with a through slot, one end of the crank is connected to the motor and the other end is coupled to the through slot of the slider, the motor drives the crank to rotate, and one end of the crank slides within the through slot and drives the slider to move between the first position and the second position.

11. The flushing toilet for a cat according to claim 8, wherein the bottom gate further comprises a locking plate and a locking driver; the locking plate is slidably arranged on the lower surface of the bottom plate and is opposite to the slider; the locking driver is arranged on the bottom plate and is kinematically connected to the locking plate; in response to the slider being in the first position, the locking driver drives the locking plate to block beneath the lid; and in response to the slider being in the second position, the locking driver drives the locking plate away from beneath the lid, and causes the lid to open the opening of the bottom plate.

12. The flushing toilet for a cat according to claim 11, further comprising a drying module, wherein the drying module comprises a fan and at least one oscillating rod, the fan is pivotally connected to the basin body, one end of the at least one oscillating rod is connected to the locking plate, and the other end is connected to the fan.

13. The flushing toilet for a cat according to claim 1, further comprising a water absorption module, wherein the water absorption module comprises a water absorption member and a water absorption member driver, the water absorption member driver is arranged on the basin body, the water absorption member is coupled to the water absorption member driver, and the water absorption member driver is adapted to drive the water absorption member, to enable the water absorption member to selectively contact the basin body or move away from the basin body.

14. A flushing toilet for a cat, comprising:
a basin body, comprising a bottom gate and an accommodating slot, wherein the bottom gate is arranged in the accommodating slot, and the basin body is selectively arranged on a toilet;
an inflow module arranged on the basin body and configured to supply water to the accommodating slot;
a sensor arranged on the basin body; and
a controller electrically connected to the bottom gate of the basin body, the inflow module, and the sensor, wherein
in response to detecting that excrement exists in the accommodating slot or detects that a pet has used the basin body by the sensor, the controller is configured to control the flushing module to supply water to the accommodating slot, and control the bottom gate to be opened or closed:
wherein the bottom gate comprises a lid, a slider, and a driver; one end of the lid is pivotally connected to a lower surface of a bottom plate of the basin body, and an opening of the bottom plate is selectively closed or opened by the lid; the slider is slidably arranged on the lower surface of the bottom plate; the driver is arranged on the bottom plate, and is configured to drive the slider to move between a first position and a second position; in response to the slider being in the first position, the slider blocks beneath the lid and causes the lid to close the opening of the bottom plate; and in response to the slider being in the second position, the slider moves away from beneath the lid, and causes the lid to open the opening of the bottom plate.

15. The flushing toilet for a cat according to claim 14, further comprising a drying module, wherein the drying module comprises a fan arranged on a side of the basin body and electrically connected to the controller, and when the controller controls the bottom gate to be opened, the controller activates the fan.

16. The flushing toilet for a cat according to claim 14, further comprising a cat litter supply module, wherein the cat litter supply module is arranged on the basin body and electrically connected to the controller: the controller is configured to control the cat litter supply module to dispense the cat litter to the accommodating slot.

17. The flushing toilet for a cat according to claim 14, further comprising a water absorption module, wherein the water absorption module comprises a water absorption member and a water absorption member driver, the water absorption member driver is arranged on the basin body and electrically connected to the controller, the water absorption member is coupled to the water absorption member driver; the controller is configured to control the water absorption member driver to drive the water absorption member, to enable the water absorption member to selectively contact the accommodating slot or move away from the accommodating slot.
